(19) United States
(12) Patent Application Publication
(10) Pub. No.: US 2024/0086487 A1
(43) Pub. Date: Mar. 14, 2024

(54) A System for Pointing to a Web Page

(71) Applicant: TEKKPRO LIMITED, Harrow, Middlesex (GB)

(72) Inventors: Daniel Robert COX, Staines (GB); Daniel Robert COX, Ashford (GB)

(73) Assignee: TEKKPRO LIMITED, Harrow, Middlesex (GB)

(21) Appl. No.: 18/273,572

(22) PCT Filed: Jan. 21, 2022
(86) PCT No.: PCT/GB2022/050167

§ 371 Date: Jul. 21, 2023

(30) Foreign Application Priority Data
Jan. 21, 2021 (GB) 2100812.3

(51) Int. Cl. G06F 16/955; G06V 10/77; G06V 10/94; G06V 20/70

(52) U.S. Cl. CPC G06F 16/9566; G06V 10/77; G06V 10/945; G06V 20/70

(57) ABSTRACT

A system for pointing to a web page includes a screen displaying a moving image, a mobile camera device and access to a multiplicity of computers. The system further includes a website having a plurality of pages, each page having a Uniform Resource Locator (URL), a starting URL includes a space for at least one label and a list of labels relating to at least one characteristic an algorithm to find at least one characteristic, the system includes the steps of capturing a still image of the screen displaying the moving image, sending the still image to at least one computer, applying the algorithm to said still image to find at least one characteristic and inserting the label relating to the found characteristic into said space in said starting URL and activating that URL to take the user to a specific page or part of a page on said website.

The present invention relates to a system for pointing to and accessing a web page, a mobile camera device and a method for obtaining information relating to a live streamed event.

Presently, a user has a number of options to find a website or particular page of a website.

A website is assigned a web address, known as a URL. The user may type the web address into an address box of a web browser of a computer system, smart phone, tablet or the like to display the web page on a screen.

Alternatively, the user may use a search engine to find the website. The user thinks of a “query”, a few words which the user believes will find the website. The user then types the query into a dialogue box in a user interface landing page of a search engine displayed on a Visual Display Unit of a computer system, smart phone, tablet or the like. The search engine executes algorithms and may interrogate various databases, web pages, web page metadata and use Natural Language Processing to come up with synonyms and the like to add to the query to draw up a list of links. The results usually appear in a fraction of a second. Each link is provided with a brief description or excerpt relevant to the destination of the link. Each link is provided with a unique Uniform Resource Locator (URL). The user has the final decision by clicking on the link which the user wants to follow, which inserts the URL behind the link into the address box of the web browser, sending the user to the landing page of a particular website or a specific page of the website of interest. The URL may be static, having static content or dynamic, having content which is updated regularly. Instead of typing a query into a dialogue box, a user may use a “smart speaker”, which has an inbuilt microphone and uses voice recognition in order to convert sounds into computer readable text, such as ASCII code which is then electronically inserted into a query box of a search engine. The same list of results may be read out by through the smart speaker, display the list on a visual display unit or the search engine may take the user directly to the website at the top of the list.

Live television broadcasts are well known. Users may view these live broadcasts on: terrestrial television sets receiving broadcast radio frequency signals; and television sets receiving microwave signals, typically from satellites. More recently, such real time content is streamed over the internet to smart televisions, smart phones, tablets, desktops and laptops. Typically, such live broadcasts are news broadcast, sporting events, concerts, theatrical events and sales channels.

Very recently, it has become known for news networks to display a QR code in an overlay over the live broadcast. A user may use a camera on a smart phone or tablet and point the camera at the screen so that the QR code is the field of view and field of focus of the camera. The smart device automatically detects the presence of the QR code, reads the QR code and automatically displays a message on the smart phone or tablet offering the user a link to a website associated with the QR code.

The inventors have observed that this requires an active step to be provided by the broadcast network to provide a QR code on an overlay so it can be viewed by the user along with the broadcast content.

There are many billions of web pages accessible on the internet and thus there are many technical problems associated with finding a page which will be of interest to the user. In time critical environments, saving seconds to accomplish this is of utmost importance.

In accordance with the present invention, there is provided a system for pointing to a web page, the system comprising a screen displaying a moving image, a mobile camera device with a connection to internet and access to a multiplicity of computing devices in the internet, the system further comprising a website having a plurality of pages, each page having a Uniform Resource Locator (URL), a starting URL comprising a space for at least one label, said system further comprising a list of labels, each label relating to at least one characteristic which is likely to be in the moving image, a machine learning cloud provided with an algorithm to find at least one characteristic associated with a label from said list of labels, the system comprising the steps of capturing a still image of the screen displaying the moving image with said mobile camera device, sending the still image from the mobile camera device over the internet to at least one computing device of said multiplicity of computing devices, applying the algorithm to said still image to find at least one characteristic of the list of characteristics, upon finding said characteristic, the system inserting the label relating to the found characteristic into said space in said starting URL and activating that URL to take the user to a specific page or part of a page on said website. The URL comprises a string of terms separated by a separator, such as a forward slash. The space may be provided after or between such separators.

Optionally, the mobile camera device is one of: a smart phone; a tablet; a smart watch; and smart spectacles. Smart phones generally comprise a screen, a processor and circuitry for providing both cellular data and Wi-Fi data communication with the internet. Optionally, the website is accessed through an app or widget, which may launch a program having a web browser embedded therein.

Optionally, the still image is compressed on the mobile camera device to produce a compressed image, such as Base64 encoding.

Optionally, a characteristic of the screen displaying the moving image is an oblong: four corners with two pairs of parallel sides when viewed from directly in front, but appears as another type of quadrilateral when viewed from an angle. These details are used to detect and recognise the screen and thus define the bounds of the image to be captured and sent on to be analysed. If the user “zoomed in” such that the screen appears larger on his display, it would still identify the same position in panoramic space as if he had drawn the quadrilateral while zoomed out. An affine transformation may be employed in detecting the bounds of the screen to define the area of the image displayed thereon. This defined area is captured in the image and only the part of the entire image within the quadrilateral is analysed for characteristics used in drawing up a list of labels.

Optionally, the list of labels is stored in a database. Optionally, the moving image is of a live event, such as a live sporting event. Optionally, the characteristic is an item. In the case of a sporting event, the item may be one of: a football, goal posts, dart, dart board, tennis ball, snooker table etc.

Optionally, a further space is provided in said starting URL, the system further comprising the step of applying the machine learning based algorithm to said still image to find a further characteristic associated with a label of said list of labels, upon finding said further characteristic, the system inserting the label relating to the found further characteristic into said further space in said URL and activating that URL to take the user to a specific page or part of a page on said website. The URL comprises a string of terms separated by a separator, such as a forward slash. The further space may be provided after or between such separators. Optionally, a yet further space is provided in said URL, the system further comprising the step of applying the machine learning based algorithm to said still image to find at least one yet further characteristic associated with a label of the list of labels, upon finding said further characteristic, the system inserting the label relating to the found further characteristic into said further space in said URL and activating that URL to take the user to a specific page or part of a page on said website.

Optionally, the system further comprises the step of prompting the user to take the still image in landscape mode. Optionally, the system comprises a computer program or sub routine to automatically capture a still image upon recognising that the screen is within a predefined field of view and in focus.

The present invention also provides a mobile camera device provided with instructions to carry out the steps set out herein.

The present invention also provides a system for obtaining information relating to a live streamed event, the system comprising a screen displaying a live streamed event, a mobile camera device with a connection to internet and access to a multiplicity of computers in the internet, the system further comprising a website having a plurality of pages, each page having a Uniform Resource Locator (URL), a starting URL comprising a space for at least one label, said system further comprising a list of labels, each label relating to at least one characteristic which is likely to be in the live streamed event, a machine learning cloud provided with an algorithm to find at least one characteristic associated with a label from said list of labels, the system comprising the steps of capturing a still image of the screen displaying the live streamed event with said mobile camera device, sending the still image from the mobile camera device over the internet to at least one computer of said multiplicity of computers, applying the algorithm to said still image to find at least one characteristic of the list of characteristics, upon finding said characteristic, the system inserting the label relating to the found characteristic into said space in said starting URL and activating that URL to take the user to a specific page or part of a page on said website.

The present invention also provides a method for obtaining information relating to a live streamed event, wherein a live streamed event is displayed on a screen, a mobile camera device has a connection to internet and access to a multiplicity of computers in the internet, a website having a plurality of pages, each page having a Uniform Resource Locator (URL), a starting URL comprising a space for at least one label, a list of labels, each label relating to at least one characteristic which is likely to be in the live streamed event, a machine learning cloud provided with an algorithm to find at least one characteristic associated with a label from said list of labels, the method comprising the steps of capturing a still image of the screen displaying the live streamed event with said mobile camera device, sending the still image from the mobile camera device over the internet to at least one computer of said multiplicity of computers, applying the algorithm to said still image to find at least one characteristic of the list of characteristics, upon finding said characteristic, the method inserting the label relating to the found characteristic into said space in said starting URL and activating that URL to take the user to a specific page or part of a page on said website.

The present invention also provides a system for pointing to a web page, the system comprising a viewing device comprising a screen displaying a moving image, and a processor with a connection to internet and access to a multiplicity of computers in the internet, the system further comprising a website having a plurality of pages, each page having a Uniform Resource Locator (URL), a starting URL comprising a space for at least one label, said system further comprising a list of labels, each label relating to at least one characteristic which is likely to be in the moving image, a machine learning cloud provided with an algorithm to find at least one characteristic associated with a label from said list of labels, the system comprising the steps of capturing a still image of the screen displaying the moving image with screen capture algorithm, sending the still image from the viewing device over the internet to at least one computer of said multiplicity of computers, applying the algorithm to said still image to find at least one characteristic of the list of characteristics, upon finding said characteristic, the system inserting the label relating to the found characteristic into said space in said starting URL and activating that URL to take the user to a specific page or part of a page on said website.

Optionally, the viewing device is one of: a smartphone; a tablet; a laptop and a desktop computer.

Optionally, the processor comprises a micro-processor and a storage memory, the storage memory storing an operating system program, the micro-processor for performing instructions that are passed from the operating system program. The device may also comprise a video display controller for turning data into electronic signals to send to the screen for facilitating display of the moving image.

Optionally, the still image is a screenshot of the entire screen.

Optionally, the still image is a screenshot of a window in which said moving image is displayed.

For a better understanding of the present invention, reference will now be made, by way of example, to the accompanying drawings, in which:

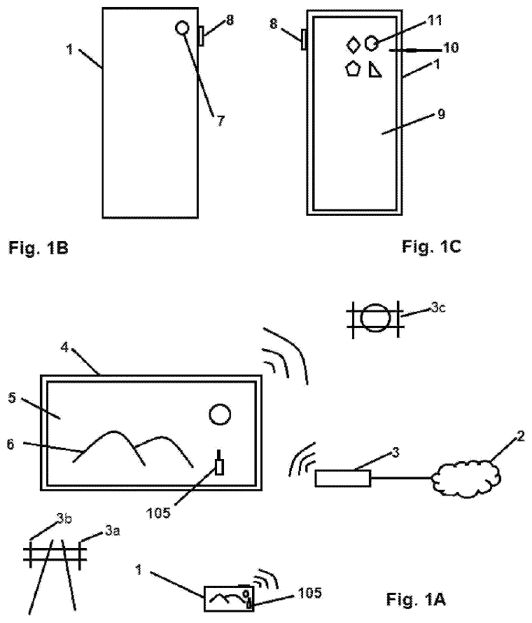

FIG. 1A is a schematic view of a system in accordance with the present invention incorporating a smart phone;

FIG. 1B is a schematic view of a rear face of the smart phone shown in FIG. 1A;

FIG. 1C is a schematic view of a front face of the smart phone shown in FIG. 1A;

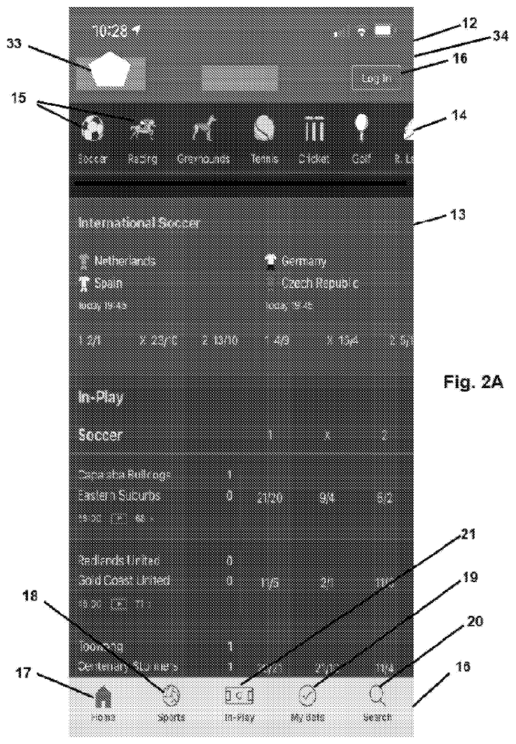

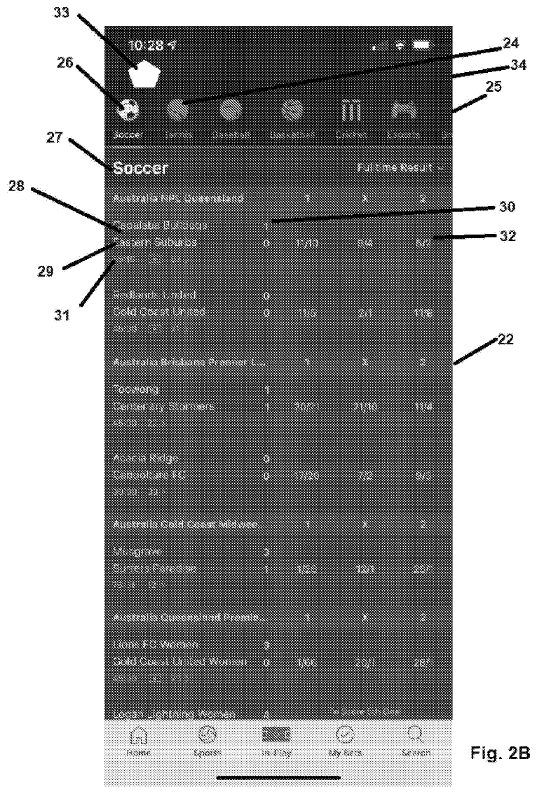

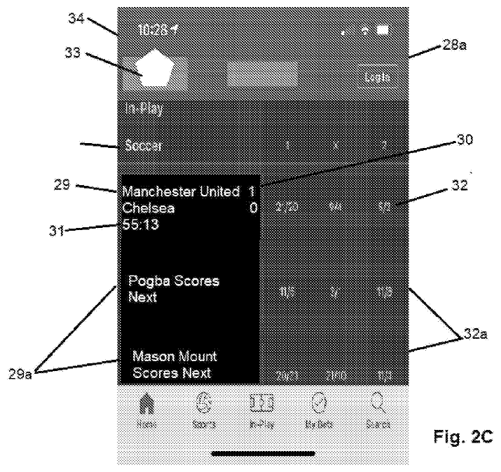

FIG. 2A is a home page of an application program run on the smart phone of the system shown in FIG. 1A;

FIG. 2B is an in-play user interface of the application program run on the smart phone of the system shown in FIG. 1A;

FIG. 2C is an in-play match specific user interface of the application program run on the smart phone of the system shown in FIG. 1A;

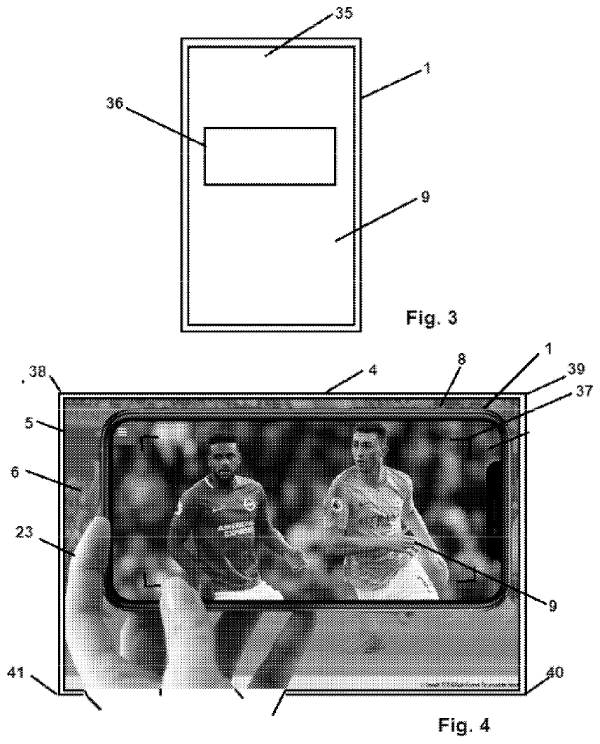

FIG. 3 is a further user interface of the application program run on the smart phone in portrait orientation of the system shown in FIG. 1C, with a pop up window;

FIG. 4 is the further user interface of the application program run on the smart phone in landscape orientation of the system shown in FIG. 1C;

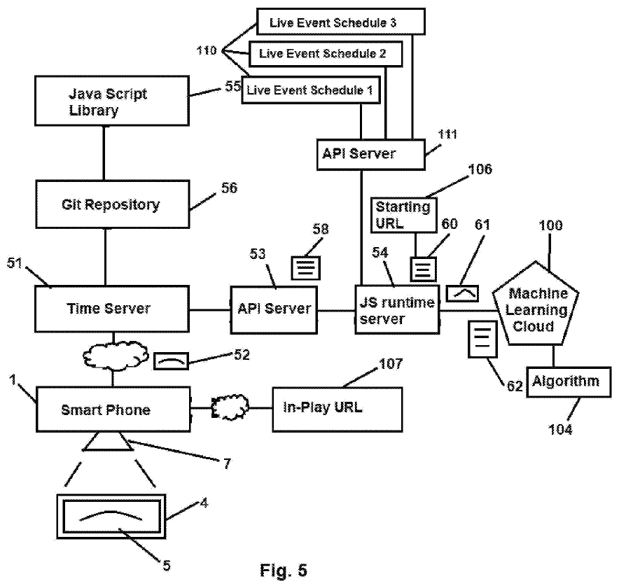

FIG. 5 is a flow diagram of part of the system shown in FIG. 1C; and

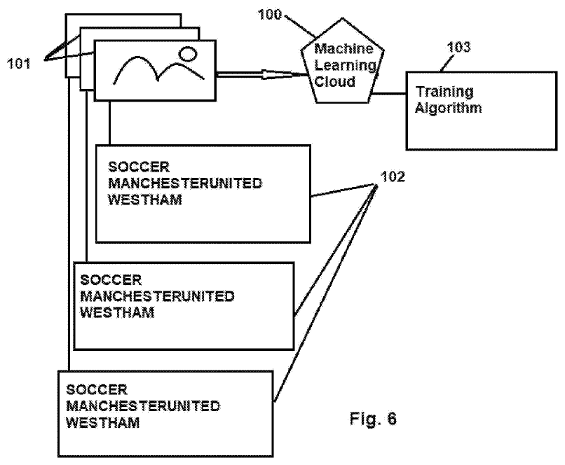

FIG. 6 is a flow diagram showing steps in training the machine learning cloud.

Referring to FIGS. 1A, there is shown a schematic view of a system in accordance with the present invention. The system comprises a smart phone 1, although the smart phone 1 may be any mobile camera device such as a tablet, a smart watch or smart spectacles. The smart phone 1 has access to the internet 2 via Wi-Fi through a home router 3 or over a mobile data network 3a, such as 4G and 5G.

A smart television 4 is also provided with Wi-Fi communication having access to the internet 2 via the router 3 or mobile data network 3a. The smart television has an electronic visual display 5 displaying a live moving image 6 streamed from the internet 2. The visual display 5 may be oblong oriented in landscape and have an aspect ratio of 16:9, 4:3 or 2.4:1 or any other suitable aspect ratio. As an alternative, the live moving image 6 may be broadcast and received over terrestrial radio frequency bands from a terrestrial mast 3b or received from satellite 3c over microwave frequency bands.

The smart phone 1 comprises a camera lens 7 and a button 8 for taking a picture. The smart phone 1 is shown in FIG. 1C having the lens 7 facing the electronic visual display 5 of the smart television 4. The electronic visual display 5 is oblong and oriented in landscape.

The smart phone 1 has a screen 9, an internal battery (not shown) and at least one processor and memory storage (not shown). As shown in FIG. 1C, the screen 9 displays a plurality of icons 10 which are either executable application programs or links to executable programs and/or user interface. Such icons 10 may be “apps” or “widgets”.

There is displayed an icon 11 which is a link to execute an application program providing a user interface and communication with an online bookmaker service. Selecting the icon 11 opens a user interface, such as the home page 12 shown in FIG. 2A. The home page 12 typically provides: a section 13 providing information on the most important upcoming sporting events, with team or player names and odds for various outcomes. The home page 12 typically provides a sports options bar 14 displaying a plurality of sports navigating icons 15. Each navigating icon 15 is an image relating to a specific sport, such as an image of a football for soccer, a horse for horse racing, a tennis ball for tennis etc. Each sport's navigating icon 15 provides a link to specific betting page relating to the specific sport. The home page 12 has a “log-in” icon 16 which provides a link to a repository for user details, such as name, contact details, and payment details, such the user's credit card, debit card or bank details. Once a user has entered details into the repository, the smart phone's security programs, such as Apple's Key Chain may recognise the application program and automatically keep the user logged in upon the user opening the application program when initially clicking on icon 11. The home page 12 provides a fixed options bar 16 which is permanently displayed whilst the application program is in use. The fixed options bar 16 displays a plurality of fixed navigating icons, such as: a home button 17 providing a link to the home page 12; a sports button 18 proving a link to a page comprising links to the sports found in sport options bar 14; a My Bets icon 19 providing a link to a page displaying the users current and previously placed bets; a general search query icon 20 providing a link to a page incorporating a search query box; and an in-play icon 21 for providing a link to an in-play user interface 22 shown in FIG. 2B.

The in-play user interface 22 comprises an in-play sports options bar 25 displaying a plurality of in-play navigating icons. Each in-play navigating icon is an image relating to a specific sport, such as an image of a football 26 for soccer, a horse for horse racing, a tennis ball 24 for tennis etc. Each sport's in-play navigating icon provides a link to specific betting page relating to the specific sport. The in-play user interface 22 shows that soccer in-play navigating icon 26 selected, displaying an in-play soccer page 27 with separate soccer match sections 28 for each soccer match which is currently being played. Each soccer match section 28 displays: team names 29; a real-time score 30; time elapsed or time remaining 31; and odds 32 for final outcomes, which can be selected by a user for placing a bet. The in-play user interface is known to use the following URL:
https://sports.williamhill.com/betting/en-gb/in-play/SOCCER

Clicking on one of the soccer match sections 28 takes the user to an in-play match specific user interface 28a, such as shown in FIG. 2C. The in-play match specific user interface 28a displays: team names 29; a real-time score 30; time elapsed or time remaining 31; and odds 32 for final outcomes; a list of potential events 29a; and odds 32a for the outcome of the potential events. which can be selected by a user for placing a bet. The match specific in-play user interface is known to use the following URL:
https://sports.williamhill.com/betting/en-gb-in-play/SOCCER/MANCHESTUNITED

Also displayed is a “StreekBet” button 33 in a top right-hand corner of a fixed header bar 34. The fixed header bar 34 remains static whilst navigating any screen of the application program, including inter alia the home page 12 and in-play user interfaces 22 and 28a shown in FIGS. 2A, 2B and 2C respectively. Selecting the “StreekBet” button 33 executes an opening computer program 50 having: an opening subroutine which opens a page 35; a camera opening subroutine which opens the camera function of the smart phone 1 and prompts the user 23 to take a photograph of the live streamed sporting event 6 displayed on the user's smart television 4. The camera opening subroutine also comprises code to obtain orientation information from the smart phone 1. The smart phone 1 has a geomagnetic field sensor (not shown) and at least one accelerometer (not shown) to detect orientation of the smart phone. The smart phone is provided with software to interpret information obtained from the geomagnetic field sensor (not shown) and at least one accelerometer (not shown) to glean the orientation of the smart phone 1 and provide an output comprising at least the two positions: “PORTRAIT”, wherein the camera is currently in portrait orientation and “LANDSCAPE” wherein the camera is currently in a landscape orientation. The camera opening subroutine obtains this data via an interface routine. If the data indicates the smart phone 1 is held in a portrait orientation, a dialogue box 36 opens automatically requesting the user to change the orientation of the smart phone 1 to landscape, as shown in FIG. 4. Once the smart phone 1 is in landscape orientation, the user 23 is prompted to take a picture of the live streamed sporting event shown on the screen 5 of the smart television 4.

Although it is preferred to have the picture captured in landscape, it is possible for the system of the invention to use images captured in portrait or indeed at a angle between landscape and portrait.

The opening sub routine for constructing the user interface and user interface components is optionally written in Java Script optionally using RACT.JS 55 and optionally using a distributed version-control system 56 for tracking changes in source code during software development, such as a GIT host repository. Reconciliation may be used, where a virtual Document Object Model (VDOM) may be used where an ideal or virtual, representation of the user interface is kept in memory and synced with the real DOM by a library such as ReactDOM. The opening computer program may be stored on a time server 51.

The user 23 may manually capture an image of the screen 5 of the live sporting event 6 displayed thereon by pressing the smart phones normal camera button 8. Optionally or additionally, the opening page 35 includes corner alignment prompts 37 and the opening computer program has an automatic capture sub routine which detects the four corners 38, 39, 40 and 41 of the smart television. As viewed on the display 9 of the smart phone 1, if the user 23 directs the camera 7 at the smart television 4 in a manner in which the image of the four corners 38 to 41 of the smart television 4 are in approximate alignment with respective corner alignment prompts 37, and the image is in focus, the automatic capture sub routine automatically captures the image, without the need for the user to press the camera button 8 to capture the image.

The automatic capture sub routine is optionally written in Java Script and may be kept on the smart phone 1 or the time server 51.

A services computer program comprises a compression sub routine, which activates a compression algorithm held on the smart phone 1 to create a compressed image packet 52. The compression algorithm may be Base64 encoding. The compression sub routine is executed locally on the smart phone 1. The compressed image packet is sent over the internet 2 in the form of binary data to a time server 51 and/or a runtime server 54.

The runtime server 54 is a server on which an executable program is stored, such as the services computer program 60. A suitable runtime server 54 may be a NODE.JS which enables the services computer program to be written in Java Script and stored thereon. NODE.JS provides real-time websites with push capability to run the JavaScript programmes with non-blocking, event-driven I/O paradigm; real-time, two-way connections; uses non-blocking, event-driven I/O data-intensive real-time applications that run across distributed devices. The runtime server 54 may form part of an Amazon Web Server (AWS) service providing Application Program Interfaces. Amazon API Gateway is an AWS (Amazon Web Service) service for creating, publishing, maintaining, monitoring, and securing REST, HTTP, and WebSocket APIs creating APIs that other web services, as well as data stored in the AWS Cloud.

The compressed image packet 52 unpacks the compressed data and compresses the data in and may add various tags, metadata and other information To produce a prepared image packet 61. The image may be analysed for a characteristic of the screen 5 displaying the moving image. Such a characteristic may be the overall shape of the screen as an oblong: four corners with two pairs of parallel sides when viewed from directly in front, but appears as another type of quadrilateral if the image was captured from a different viewing angle. These details may be used to detect and recognise the screen 5 and thus define the bounds of the image to be sent on to be analysed. An affine transformation may be employed in detecting the bounds of the screen to define the area of the image displayed thereon, as the quadrilateral may be within only part of the image. This defined area is captured in the image and only this part of the entire image within the quadrilateral is analysed using steps set forth herein for detecting characteristics used in drawing up a list of labels. In this way, superfluous image data surrounding the screen is discarded and not analysed, reducing unnecessary computational analysis; reducing noise in the system. REpresentational State Transfer (REST) architecture is used to initiate a connection with a machine learning cloud 100. The prepared image packet 61 is sent to the machine learning cloud 100.

The machine learning has been trained to look for specific characteristics of a sport and optionally teams and optionally players. Each sport, team and player is assigned a label during the training of the machine learning cloud. Such labels for sport are: “SOCCER” for an identified soccer match; CRICKET for an identified cricket match; “SNOOKER” for an identified snooker match; “BASEBALL” for an identified baseball game; etc. Such labels for teams are: “MANCHESTERUNITED” for Manchester United soccer club; “CHELSEA” for Chelsea soccer club; “ARSENALWFC” for Arsenal Women's Football Club; “NEWENGLANDPATRIOTS” for New England Patriots American Football Club; “BATH” for BATH Rugby football team; etc. For players, “RONALDO” for Cristiano Ronaldo football player; “MOFARAH” for Mo Farah long distance runner; etc.

The Machine Learning Cloud 100 has a training algorithm 103, such as that used in machine learning cloud known as AutoML. The training algorithm 103 is trained by following the steps shown in FIG. 6 to produce a usable algorithm 104. The first step is to identify characteristics which indicate that a certain sport is being played and the teams taking part. For example:

A UK Premier League men's soccer match Manchester United v West Ham. The first team name indicates that the match is played at Manchester United's home playing ground, Old Trafford. The training algorithm can identify the sport and teams by detecting any of the various characteristics set out within the algorithm, such as:
1) logo of both teams on team jersey;
2) jersey colour of the players;
3) jersey number of the player;
4) number of players of a pitch;
5) playing ground details;
6) shape and size of the ball;
7) goal posts
8) gallery
9) side lines
10) corner flags

The training algorithm 103 is trained by inputting a large quantity of data of the type expected in the compressed image packet 22. The expected, positive data used to train the machine learning cloud 100 is thus hundreds or preferably thousands and most preferably millions of still images 101:
a. taken from broadcast video footage of prior matches between Manchester United and West Ham at Old Trafford;
b. taken of logos of each team;
c. taken of jersey colours for this season;
d. taken of number of players on the pitch;
e. taken of playing ground details; and
f. taken of any other distinguishing features, such as shape and size of the ball, goal posts, gallery, side lines and corner flags.

These are each provided with labels: “SOCCER”, “MANCHESTUNITED” and “WESTHAM”.

The training algorithm 103 is also trained using false positive data, such as a woman's match between Manchester United v West Ham. This helps train the algorithm to differentiate between men's and women's matches.

This step is carried out for as many permutations as is reasonable for soccer, such as: West Ham v Manchester United with the labels “SOCCER”, “WESTHAM”, “MANCHESTERUNITED”; Manchester United v Chelsea with the labels “SOCCER”, “MANCHESTERUNITED”, “WESTHAM”; Chelsea v West Ham with the labels “SOCCER”, “CHELSEA”, “WESTHAM”; etc.

The training algorithm 103 is then tested with images from live events. If there is a good degree of accuracy, the algorithm is placed use. The Machine Learning Cloud 100 has now been trained to a reasonable degree of accuracy and now has a useable algorithm 104 which is used in the system. Referring back to the diagram shown in FIG. 5, the machine learning cloud 100 applies the useable algorithm 104 to the prepared image packet 61. The useable algorithm 104 outputs labels file 62 appropriate to the content of the image 52, for example the labels file comprises three labels: “SOCCER”, “MANCHESTERUNITED” and “CHELSEA” to the services computer program 60 held on the runtime server 54. The services computer program 60 comprises a URL subroutine which takes a starting URL string 106, such as:
https://sports.williamhill.com/betting/en-gb/in-play-
   and adds the output labels to form a known final match specific in-play URL String 107, such as:
https://sports.williamhill.com/betting/en-gb/in-play/SOCCER/MANCHESTERUNITED

In this case, only the first labels “SOCCER” and “MANCHESTERUNITED” are needed to get to the desired user interface 28a. The service computer program 60 executed on the runtime server 54 sends the final match specific in-play URL string to the smart phone 1 and inserts the final match specific in-play URL string to take the user 23 to the match specific in-play user interface 28a. The user can now choose and place a bet, such as Mason Mount to score next with odds 10:1.

The training of the machine learning algorithm 103 may be on going, starting with the useable algorithm 104 and training the algorithm further and then replacing the previous version of the useable algorithm 104 with the newly trained useable version of the algorithm. For instance, the colour of the jerseys may change from one season to the next, thus continuous training is required to maintain accuracy. Each time the training algorithm 10 is trained to a sufficient extent, it is tested with real live data and once tests have been passed, the useable algorithm 104 is replaced with the newly trained algorithm.

The useable algorithm 104 may also trained to detect other sports, such as cricket. The training algorithm 103 can identify the sport by detecting any of the various characteristics set out within the algorithm, such as:

For cricket
1. Identify the position of player
2. Size of red ball
3. White uniform of the players
4. Identify stumps
5. Identify long bat 105, as shown in FIG. 1A.

It is less likely that there will be more than one match on at any one time, so the useable algorithm 104 will simply output label “CRICKET”.

For darts
1. Dart object
2. View of a single player
3. Throwing action
4. Visual of a dart board
5. Fancy dress costumes in a crowd
6. Facial recognition of player

Output labels: “DARTS” and optionally, players name such as “PHILTAYLOR”.

For tennis
1. 2 players in view
2. Court
3. Small green ball
4. Players wearing white shorts/skirt
5. Facial recognition of player

Output labels: “TENNIS” and optionally, players name such as “FEDERER”.

For snooker
1. Size/Colour of the table
2. Green Table Cloth
3. Size and length of the stick (cue)
4. Position of the holes
5. Group of small coloured balls
6. Movement/speed of the ball
7. Direction of movement of the ball

Output labels: “SNOOKER”

Optionally, the service computer program 60 may also comprise a listings sub routine to interrogate live event schedules 110 from third parties. The labels file 62 obtained from the machine learning cloud is opened by computer program 60 and individual labels extracted. The labels are used in interrogating the live event schedules 110 provided by third parties. These may be television schedules and live sporting event schedules. The schedules may be passed through or obtained from an API server 111 in an API feed, such as:
https://www.thesportsdb.com/api/v1/json/1/enventstv.php?c=TSN_1

The data in the schedule is reduced by filtering by current time for live events. The schedules are interrogated using the labels such as “SOCCER”, “MANCHESTERUNITED” and “CHELSEA”. The listings sub routine may also comprise or have access to a data base of synonyms for each label, such as “MANCHESTER UNITED” and “MANCHESTER UTD” for the label “MANCHESTERUNITED” or use a third party Natural Language Processing software to produce a list of synonyms for use in interrogating the live event listings. If an exact is found, the step of inserting the labels into the starting URL string is carried out, as described above, to obtain a final match specific in-play URL. The final match specific in-play URL is activated on the smart phone 1 of the user 23 as described above and sent to:
https://sports.williamhill.com/betting/en-gb/in-play/SOCCER/MANCHESTERUNITED

However, this may produce a result such as:
Result (1): Manchester United V Everton are playing live on Sky Sports Main Event Channel
Result (2): Chelsea v Southampton are playing live on BT Sports

The user is either sent to:
https://sports.williamhill.com/betting/en-gb/in-play/SOCCER/MANCHESTERUNTIED
   with a message box displaying a notice “Please check this is the correct live match”

Or sent to the general in-play user interface 28:
https://sports.williamhill.com/betting/en-gb/in-play/SOCCER/

Optionally, a user information database (not shown) may be compiled from the user's activity using the “StreekBet” product and service. Such a user database may be compiled in an Structured Query Language (SQL) database. Such information which would be stored in such a =database is: data profile, betting history and Sport viewing behaviour.

The Machine Learning Cloud is trained to look for an item. The training is provided by giving the Machine Learning Cloud a large number of images containing the item. The images are typically images which would include background information to provide a context to the item. provided with a multiplicity of images

A possible use for this technology may be found in betting. A user may be watching a sporting event on a live stream across the internet on a screen of a smart television. The sporting event may be a soccer match. From watching the first few minutes of the first half, the user may be of the opinion that a player, number 12, Mason Mount, is playing well and is likely to score. The user wants to place a bet on Mason Mount scoring. Accessing the correct page on a betting website is vital to get the punter's bet made as soon as possible. Using the present invention, the user opens his preferred betting app on his phone. The user selects an option to use the present invention, which opens the camera function on the smart phone. The user is prompted to take a picture of the screen in landscape in order to get at least the majority of the screen in the camera's field of view. The still image is compressed. The compressed still image is automatically sent across the internet to the Machine Learning Cloud. The Machine Learning Cloud is programmed to look for parts of the image which characterises the sport.

In another embodiment of the invention, the moving image, such as a live streamed sporting event is being watched by a user on a viewing device, such as a smartphone; a tablet; a laptop and a desktop computer. In such a scenario, the user may take a screen shot of the moving image. The user switches to the home page 12 of the betting app and presses the “StreekBet” icon 33, which activates an algorithm to look for an open window playing a live streamed event and automatically takes a screen shot of the window displaying the live streamed event. The screen shot is a still image, which is then uploaded directly from the viewing device to the time server 51, API server 53, JS runtime server 54 and machine learning cloud 100, as hereinbefore described which yields a label which is inserted into a space provided in a starting URL 106 to form a complete in-play URL to point to a desired web page, which is automatically actioned to send the user to the relevant in-play web page.

1. A system for pointing to a web page, the system comprising a screen (5) displaying a moving image, a mobile camera device (1) with a connection to internet (2) and access to a multiplicity of computers in the internet, the system further comprising a website (12,2828a) having a plurality of pages, each page having a Uniform Resource Locator (URL), a starting URL comprising a space for at least one label, said system further comprising a list of labels, each label relating to at least one characteristic which is likely to be in the moving image, a machine learning cloud (100) provided with an algorithm (104) to find at least one characteristic associated with a label from said list of labels, the system comprising the steps of capturing a still image of the screen displaying the moving image with said mobile camera device, sending the still image from the mobile camera device over the internet to at least one computer of said multiplicity of computers, applying the algorithm (104) to said still image to find at least one characteristic of the list of characteristics, upon finding said characteristic, the system inserting the label relating to the found characteristic into said space in said starting URL and activating that URL to take a user to a specific page or part of a page on said website.

2. The system of claim 1, wherein said mobile camera device is one of: a smart phone; a tablet; a smart watch; and smart spectacles.

3. The system of claim 1, wherein the website is accessed through an app or widget (11).

4. The system of claim 1, wherein said still image is compressed on the mobile camera device to produce a compressed image (52).

5. The system of claim 1, wherein the list of labels is stored in a database.

6. The system of claim 1, wherein the moving image is of a live event.

7. The system of claim 1, wherein the characteristic is an item.

8. The system of claim 1, wherein a further space is provided in said starting URL, the system further comprising the step of applying the machine learning based algorithm to said still image to find a further characteristic associated with a label of said list of labels, upon finding said further characteristic, the system inserting the label relating to the found further characteristic into said further space in said URL and activating that URL to take the user to a specific page or part of a page on said website.

9. The system of claim 8, wherein a yet further space is provided in said URL, the system further comprising the step of applying the machine learning based algorithm to said still image to find at least one yet further characteristic associated with a label of the list of labels, upon finding said further characteristic, the system inserting the label relating to the found further characteristic into said further space in said URL and activating that URL to take the user to a specific page or part of a page on said website.

10. The system of claim 1, further comprising the step of prompting the user to take the still image in landscape mode.

11. The system of claim 1, comprising a computer program or sub routine to automatically capture a still image upon recognising that the screen is within a predefined field of view and in focus.

12. (canceled)

13. A system for obtaining information relating to a live streamed event, the system comprising a screen (5) displaying a live streamed event, a mobile camera device (1) with a connection to internet (2) and access to a multiplicity of computers in the internet, the system further comprising a website (12,2828a) having a plurality of pages, each page having a Uniform Resource Locator (URL), a starting URL comprising a space for at least one label, said system further comprising a list of labels, each label relating to at least one characteristic which is likely to be in the live streamed event, a machine learning cloud (100) provided with an algorithm (104) to find at least one characteristic associated with a label from said list of labels, the system comprising the steps of capturing a still image of the screen displaying the live streamed event with said mobile camera device, sending the still image from the mobile camera device over the internet to at least one computer of said multiplicity of computers, applying the algorithm (104) to said still image to find at least one characteristic of the list of characteristics, upon finding said characteristic, the system inserting the label relating to the found characteristic into said space in said starting URL and activating that URL to take a user to a specific page or part of a page on said web site.

14. (canceled)

15. A system for pointing to a web page, the system comprising a viewing device comprising a screen (5) displaying a moving image, and a processor with a connection to internet (2) and access to a multiplicity of computers in the internet, the system further comprising a website (12,2828a) having a plurality of pages, each page having a Uniform Resource Locator (URL), a starting URL comprising a space for at least one label, said system further comprising a list of labels, each label relating to at least one characteristic which is likely to be in the moving image, a machine learning cloud (100) provided with an algorithm (104) to find at least one characteristic associated with a label from said list of labels, the system comprising the steps of capturing a still image of the screen displaying the moving image with screen capture algorithm, sending the still image from the viewing device over the internet to at least one computer of said multiplicity of computers, applying the algorithm (104) to said still image to find at least one characteristic of the list of characteristics, upon finding said characteristic, the system inserting the label relating to the found characteristic into said space in said starting URL and activating that URL to take a user to a specific page or part of a page on said website.

16. A system as claimed in claim 15, wherein said viewing device is one of: a smartphone; a tablet; a laptop and a desktop computer.

17. A system as claimed in claim 15, wherein said processor comprises a micro-processor and a storage memory, the storage memory storing an operating system program, the micro-processor for performing instructions that are passed from the operating system program.

18. A system as claimed in claim 15, wherein said still image is a screenshot of the entire screen.

19. A system as claimed in claim 15, wherein said still image is a screenshot of a window in which said moving image is displayed.
